(19) United States
(12) Patent Application Publication
(10) Pub. No.: US 2012/0233784 A1
(43) Pub. Date: Sep. 20, 2012

(54) MULTIPLE ZONE GEL CUSHION

(76) Inventor: ROBERT L. WOOD, Salt Lake City, UT (US)

(21) Appl. No.: 13/419,361

(22) Filed: Mar. 13, 2012

Related U.S. Application Data
(60) Provisional application No. 61/453,041, filed on Mar. 15, 2011.

(51) Int. Cl. A47C 17/00; B32B 3/00

(52) U.S. Cl. 5/727; 5/690; 428/195.1

(57) ABSTRACT

A gel cushion includes a first zone containing a gel matrix configured in a first pattern designed to support an object positioned thereon with a first degree of firmness. A second zone contains a gel matrix configured in a second pattern that is different from the first pattern, the second pattern being designed to support an object positioned thereon with a second degree of firmness different from the first degree. An optional third zone contains a gel matrix configured in a third pattern that is different from both the first pattern and the second pattern, the third pattern being designed to support an object positioned thereon with a third degree of firmness different from the first and the second degree.

### RELATED APPLICATION DATA

The present application claims the benefit of priority under 35 U.S.C. §119 to U.S. Provisional Application No. 61/453,041 filed Mar. 15, 2011, entitled “Five Zone Gel Cushion,” which is incorporated herein by reference.

### BACKGROUND

The present disclosure is directed generally to cushions, such as gel cushions for mattresses, toppers and the like.

Cushions made of gelatinous elastomer, gelatinous visco-elastomer, or materials with similar elastomeric characteristics are well known in the art. These gel cushions can be designed with hollow columns that collapse under specific loading and transfer load to adjacent columns thereby reducing pressure by spreading it to a larger area. Mattresses employing gel cushions can result in increased comfort, increased spine alignment and better circulation during sleep.

However, it has been found that gel cushions with a known hollow column design may provide too little support for some parts of the body. This may cause the spine to be out of alignment and/or may result in reduced comfort.

### SUMMARY

According to one embodiment, a gel cushion has a top surface, a bottom surface and an outer periphery. The gel cushion includes a first zone containing a gel matrix configured in a first pattern designed to support an object positioned on the top surface with a first degree of firmness. A second zone contains a gel matrix configured in a second pattern that is different from the first pattern, the second pattern being designed to support an object positioned on the top surface with a second degree of firmness different from the first degree. An optional third zone contains a gel matrix configured in a third pattern that is different from both the first pattern and the second pattern, the third pattern being designed to support an object positioned on the top surface with a third degree of firmness different from the first and the second degree.

By way of example, the gel cushion may include the third zone and further include a fourth zone containing a gel matrix configured in one of the first, second, or third patterns or a still different fourth pattern. Also, the gel cushion may include a fifth zone containing a gel matrix configured in one of the first, second, third, or optional fourth patterns or a still different fifth pattern. Further, the first zone and the fifth zone may be positioned at two opposite ends of the gel cushion, the second zone being positioned between the first zone and the third zone, and the fourth zone being positioned between the third zone and the fifth zone. The third zone may have a higher ILD rating than both the second zone and the fourth zone, and both the second zone and fourth zone may have a higher ILD rating than both the first zone and the fifth zone. The first gel matrix pattern, the second gel matrix pattern and the third gel matrix pattern each may form a plurality of hollow columns. Instead, the first gel matrix pattern, the second gel matrix pattern, and the third gel matrix pattern each may form a plurality of partially hollow columns. Still, the first gel matrix pattern, the second gel matrix pattern and the third gel matrix pattern each form a plurality of hollow columns that are secondarily filled with other elastomeric or flexible materials that exhibit the property of collapsing under human body pressures. The first gel matrix may be made of a different gel material than the second gel matrix. Alternatively, the first gel matrix and the second gel matrix may be made of the same, continuous material. The first gel matrix and the second gel matrix may be modular and configured to be combined to form the gel cushion after separate manufacture. The gel cushion may include a two-person sleep surface having a first person's side and a second person's side in the same gel cushion. The second person's side may include at least two zones containing respective gel matrices configured in at least two respectively different patterns at least one of which is different than the first, second, or optional third pattern of the first person's side

According to another embodiment, a gel cushion has a top surface, a bottom surface and an outer periphery. The gel cushion includes a first zone and a fifth zone containing a gel matrix configured in a first pattern designed to support an object positioned on the top surface with a first degree of firmness. A second zone and a fourth zone contain a gel matrix configured in a second pattern that is different from the first pattern, the second pattern being designed to support an object positioned on the top surface with a second degree of firmness different from the first degree. A third zone contains a gel matrix configured in a third pattern that is different from both the first pattern and the second pattern, the third pattern being designed to support an object positioned on the top surface with a third degree of firmness different from the first and the second degree, the first zone and the fifth zone being positioned at two opposite ends of the gel cushion, the second zone being positioned between the first zone and the third zone, and the fourth zone being positioned between the third zone and the fifth zone.

By way of example, the third zone may have a higher ILD rating than both the second zone and the fourth zone, and both the second zone and the fourth zone may have a higher ILD rating than both the first zone and the fifth zone. The first gel matrix pattern, the second gel matrix pattern and the third gel matrix pattern may each form a plurality of hollow columns. Instead, the first gel matrix pattern, the second gel matrix pattern and the third gel matrix pattern may each form a plurality of partially hollow columns. The first gel matrix and the second gel matrix may be made of the same, continuous material. The first gel matrix and the second gel matrix may be modular and configured to be combined to form the gel cushion after separate manufacture. The gel cushion may include a two-person sleep surface having a first person's side and a second person's side in the same gel cushion, the second person's side including at least three zones comprising respective gel matrices configured in at least three respectively different patterns at least one of which is different than the first, second, or third patterns of the first person's side.

According to a further embodiment, a gel cushion has a top surface, a bottom surface and an outer periphery, the gel cushion including a two-person sleep surface having a first person's side and a second person's side in the same gel cushion. The first person's side includes a first zone containing a gel matrix configured in a first pattern designed to support an object positioned on the top surface with a first degree of firmness. A second zone contains a gel matrix configured in a second pattern that is different from the first pattern, the second pattern being designed to support an object positioned on the top surface with a second degree of firmness different from the first degree. A third zone contains a gel matrix configured in a third pattern that is different from both the first pattern and the second pattern, the third pattern being designed to support an object positioned on the top surface with a third degree of firmness different from the first and the second degree. A fourth zone contains a gel matrix configured in one of the first, second, or third patterns or a still different fourth pattern. A fifth zone contains a gel matrix configured in one of the first, second, third, or optional fourth patterns or a still different fifth pattern. The second person's side includes a sixth, a seventh, and an eighth zone containing respective gel matrices configured in respectively different patterns. A ninth zone contains a gel matrix configured in one of the patterns of the sixth through eighth zones or a still different pattern. A tenth zone contains a gel matrix configured in one of the patterns of the sixth through ninth zones or a still different pattern, at least one of the patterns of the sixth through tenth zones being different than the first, second, third, optional fourth, or optional fifth patterns of the first person's side.

### DESCRIPTION OF THE DRAWINGS

FIGS. 1A and 1B illustrate top and side views of a gel cushion comprising a plurality of firmness zones, according to an embodiment of the present disclosure.

FIGS. 2A and 2B illustrate top and side views of a portion of a gel cushion showing a gel matrix pattern, according to an embodiment of the present disclosure.

FIGS. 3A to 6B show in like manner various additional gel matrix patterns.

FIG. 7 shows a top view of a gel cushion comprising a plurality of firmness zones with additional side-by-side firmness zones, according to an embodiment of the present disclosure.

### DETAILED DESCRIPTION

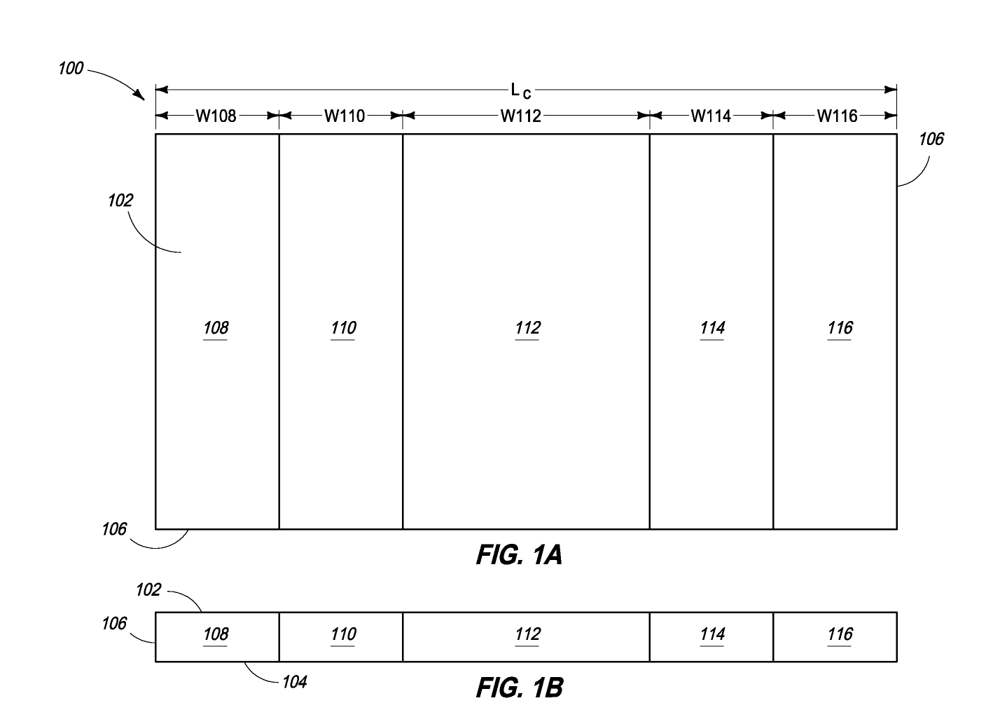

FIGS. 1A and 1B illustrate a gel cushion 100 having a top surface 102, a bottom surface 104 and an outer periphery 106. The gel cushion 100 includes a plurality of zones 108, 110, 112, 114 and 116. Each zone comprises a gel matrix configured in a pattern designed to support an object positioned on the top surface 102 with a desired degree of firmness to suspend the body within the thickness of the cushion avoiding complete compression of the cushion. In this manner, the firmness of the cushion can be tailored to support different parts of a person's body differently, so as to promote increased comfort and health.

The cushions of the present disclosure can be used, for example, as a component in a bed mattress, a mattress topper or a camping cushion or other sleep surface. Using pressure mapping, it has been found that the area of greatest pressure on a sleep surface from the human body is at the hips, whether a person is lying on their side or back. The shoulder region also generates a relatively large amount of pressure, followed by the knees. The head and feet regions generally generate the least amount of pressure.

Based on the pressure mapping data, the most beneficial sleep surface can be divided into five basic pressure zones: two zones of relatively low pressure, one for the head and one for the feet; a relatively stiffer zone for the hip region, and two intermediate pressure zones, one for the shoulders and one for the knees. So, a five-zone cushion can be designed to support the head and feet with softer zones at the two ends of the cushion, an intermediate firmness zone at the shoulders and knees, and the firmest zone in the center region of the cushion to support the hips.

Firmness of a cushion can be characterized as an ILD rating, as is well known in the art. The higher the ILD rating, the firmer the cushion. Thus, at least some of the different zones of the cushions of the present disclosure have different ILD ratings. The ILD ratings of the zones can be chosen to be any suitable firmness, from relatively soft to relatively firm. Example ILD ratings can be about 10 to about 50, or about 14 to about 40. These numbers are measures of weight in pounds (or mass in kilograms) that cause a round disk with 50 square inches of area, to deflect the cushion approximately 50 percent of its thickness. ILD ratings outside of these ranges can also be employed depending on the body shape and mass or weight of the person using the cushion.

Referring to FIG. 1A, for example, zones 108 and 116 can have the same degree of firmness, or the same ILD rating. Zones 110 and 114 can also have the same ILD rating. For example, zones 108 and 116 can have ILD ratings that provide the desired support for the head and feet, zones 110 and 114 can have a greater ILD rating than zones 108 and 116, in order to support the legs and shoulders, while zone 112 can have a still greater ILD rating than zones 110 and 114, so as to support the hips. By adjusting the relative firmness of the different zones 108 to 116, it may be possible in some instances to increase spine alignment and/or provide for a more comfortable cushion.

The difference in ILD ratings between the different zones can be chosen to vary by any suitable amount. In an embodiment, the ILD ratings of any two adjacent zones in cushion 100 can differ by values of 1 or more, such as, for example, about 1 to about 10, or about 2 to about 5, on the ILD rating scale.

The relative size of the zones can vary, as desired to accommodate the size differences of the persons using the mattress. In an embodiment, the center zone 112 can have a larger width, W₁₁₂, than the widths for each of the other zones 108, 110, 114 and 116, as shown in FIG. 1A. Alternatively, W₁₁₂ can be the same as or smaller than one or more of W₁₀₈, W₁₁₀, W₁₁₄ and W₁₁₆. In an example, W₁₁₂ can range from about 20% to about 40% percent of the total length, L_{c}, of the cushion 100, while each of W₁₀₈, W₁₁₀, W₁₁₄ and W₁₁₆ can range from about 15% to about 25% of L_{c}.

The cushion 100 is not limited to five zones, but can have any number of zones in order to tailor the firmness of the cushion in any manner desired. For example, zones 110 and 114 could be omitted to form a cushion 100 having three zones, a firmer central zone and two softer end zones. In yet another embodiment, zone 114 could be made firmer than zone 110 to provide two intermediate zones of differing firmness, a firmer intermediate zone for supporting the shoulders and a softer intermediate zone used to support the knees.

The firmness of the zones can be varied in any suitable manner. One technique for varying the firmness may be to increase the amount of gel matrix material per unit volume of the cushion. The amount of gel can be adjusted by altering the gel matrix patterns, so that the pattern in each zone has an amount of gel per unit volume of cushion that results in the desired firmness for that zone. A variety of patterns may provide the selected firmness for a given zone. In an embodiment, the gel matrix patterns can form a plurality of hollow columns, as discussed above. In this manner, just one formulation of gel material may be used to make the cushion and all of the relative firmness within the cushion depends on the configuration of the hollow columns within the zones.

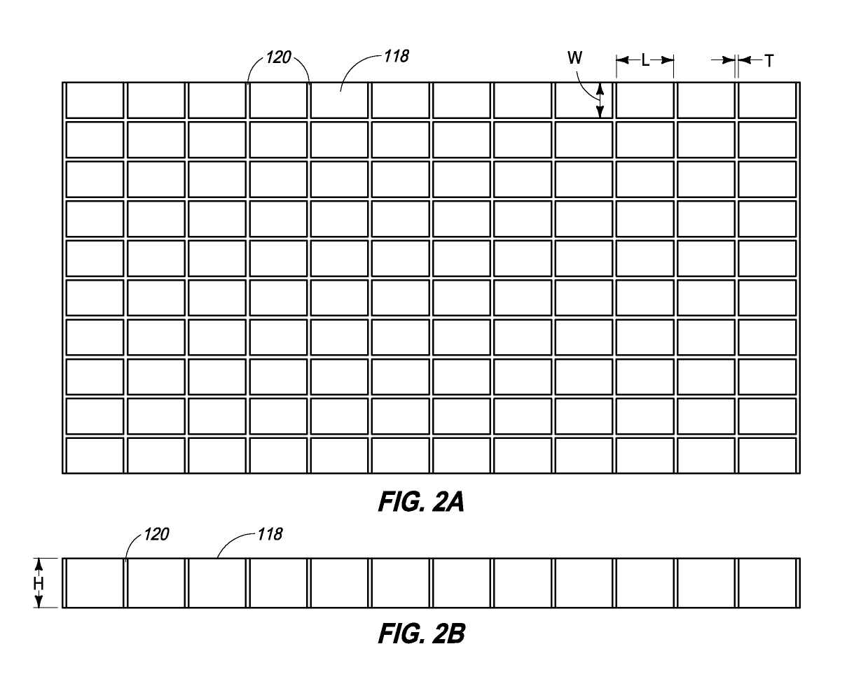

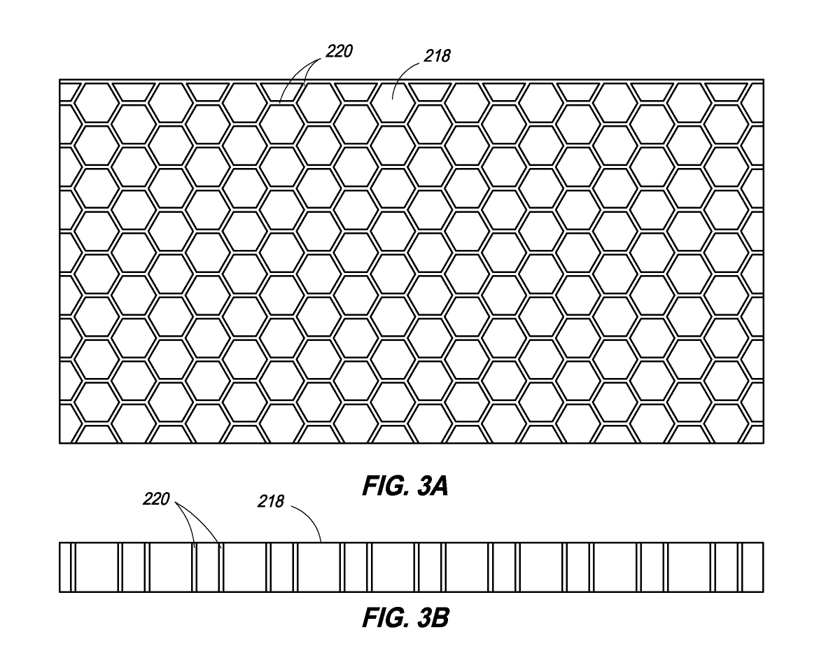

FIGS. 2A to 6B illustrate various designs in which the gel matrix pattern includes hollow columns 118, 218, 318, 418, or 518. The hollow columns 118, 218, 318, 418, or 518 can extend through part or the entire height, H, of the gel matrix 120 (see FIGS. 2A and 2B) or in like manner for gel matrix 220, 320, 420, or 520 of FIGS. 3A to 6B. FIGS. 2A and 2B show a rectangular pattern having gel walls of a thickness, T, and hollow columns having a length, L, a width, W, and a height, H. Like dimensions may be appreciated for the respective hexagonal, square, circular, and triangular patterns of FIGS. 3A to 6B. By increasing or decreasing the dimensions of the pattern, such as the thickness, length and/or width of the hollow columns, the amount of gel employed per unit volume of cushion can be increased or decrease to adjust firmness. This design allows one formulation of gel material with the relative firmness of the zones achieved in the configuration and design of the different zones within the cushion.

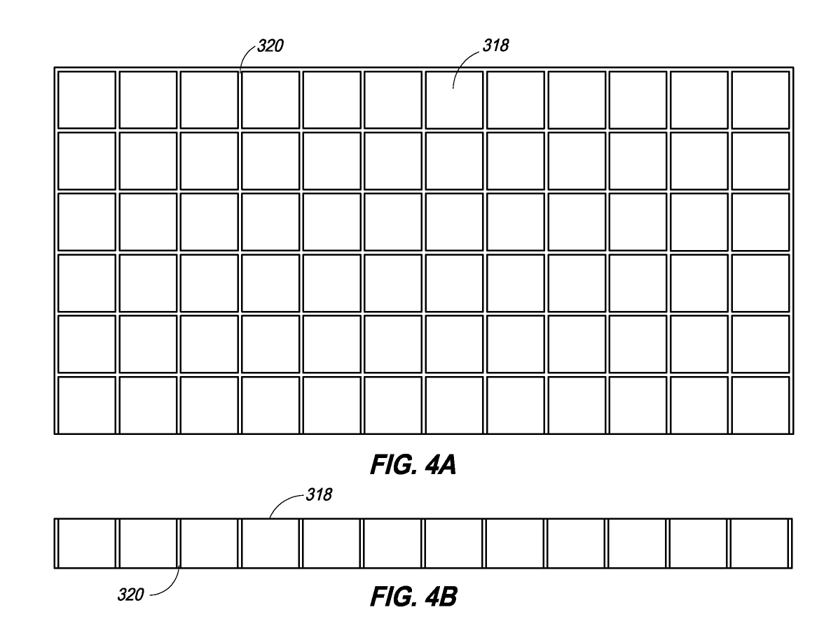

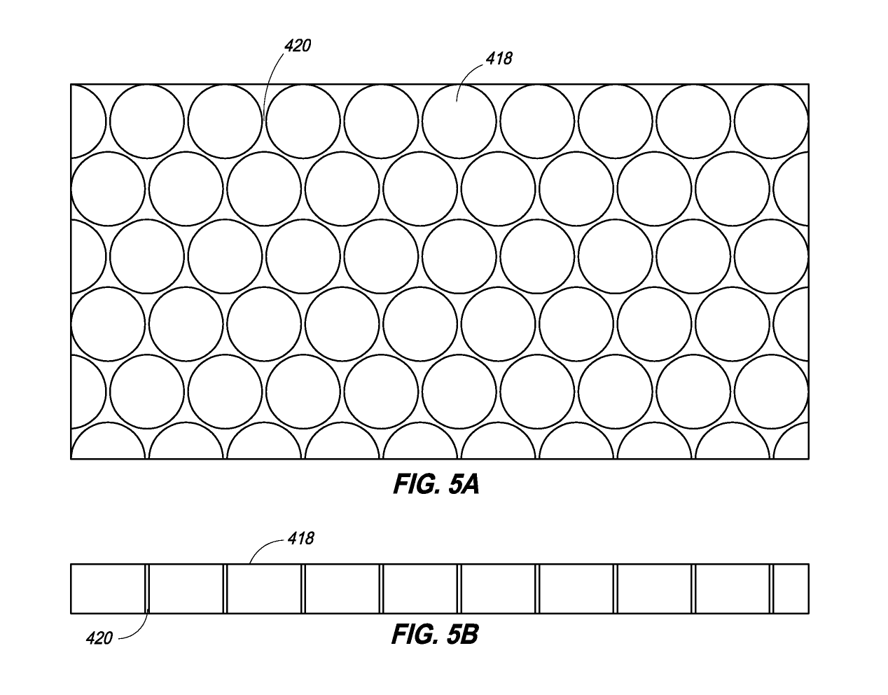

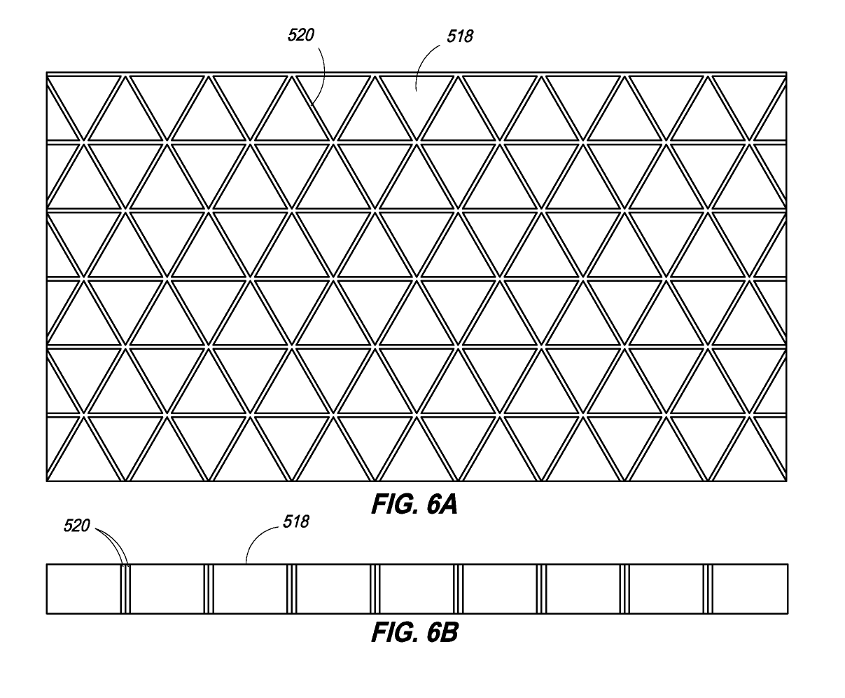

Any desired shape of the pattern (e.g., square, rectangle, triangle, circular, or hexagonal) can be used in the zones of the cushion 100. In an embodiment, the rectangular gel matrix design of FIGS. 2A and 2B could be used in zones 108 and 116; the hexagonal gel matrix design of FIG. 3A and 3B could be used in zones 110 and 114, and the square gel matrix design of FIG. 4A and 4B could be used in zone 112. The amount of gel employed per unit volume of cushion can be adjusted in each of the different shaped patterns to adjust the firmness of each. This may be accomplished by adjusting the thickness of the walls or adjusting the size of the squares, rectangles, triangles, circles, or hexagonals or by using a combination of these two adjustments. The gel material formulation may remain the same in all of the zones. The matrix designs shown in FIGS. 5A, 5B, 6A, and 6B may also be substituted into zones 108, 110, 112, 114, and 116 to create the desired shape and attributes of the mattress.

In yet another embodiment, different square gel matrix patterns, where each square pattern has a different amount of gel per volume of cushion, could be used for all zones of cushion 100. In yet another embodiment, different hexagonal, circular, triangular, square, or rectangular patterns could be employed for all zones.

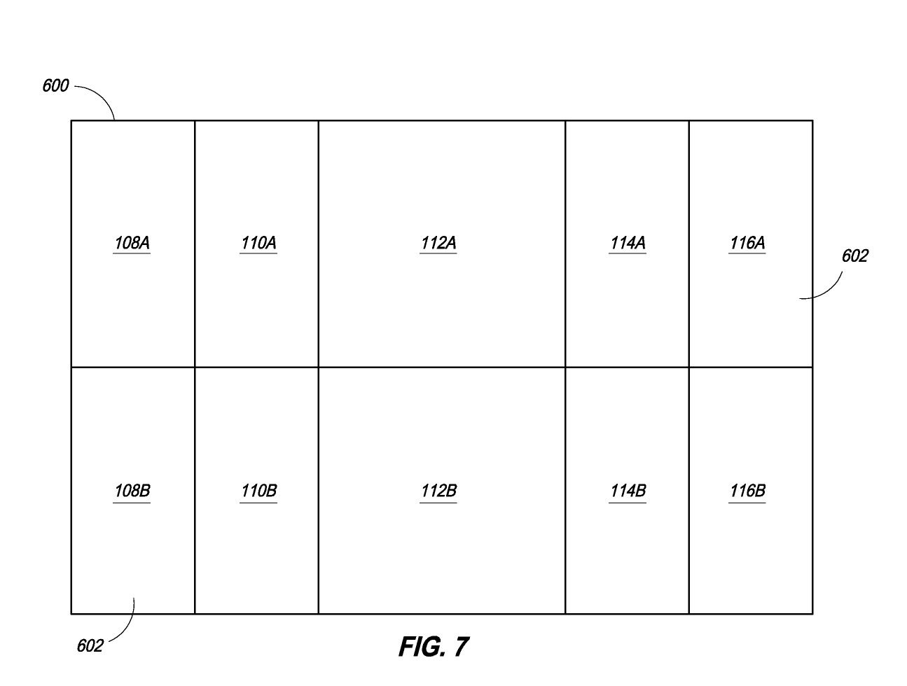

In yet another embodiment, shown in FIG. 7, the mattress may be configured to allow two different bodies to rest on the same mattress and have two different configurations of two or more zones each for customized and individual mattress support and feel. The gel cushion 600 includes a plurality of zones 108A, 110A, 112A, 114A, and 116A on a first person's side in like manner to that described above for the gel cushion 100. The gel cushion 600 also includes a plurality of zones 108B, 110B, 112B, 114B, and 116B on a second person's side. Each zone comprises a gel matrix configured in a pattern designed to support an object positioned on the top surface 602 with a desired degree of firmness to suspend the body within the thickness of the cushion avoiding complete compression of the cushion. Any of the side-by-side zones, such as 112A and 112B, may be configured with the same pattern or a different pattern to customize one side compared to the other.

Any suitable type of elastomer gel, viscoelastomer gel or other suitable gel material can be used to form the cushions of the present disclosure. Examples of well-known gel materials include those found in U.S. Pat. No. 7,076,822, the disclosure of which is hereby incorporated by reference in its entirety. In an embodiment, SEEPS triblock copolymers sold under the trade name SEPTON 4044 and/or SEPTON 4055, available from Kuraray of Japan or Septon Company of America, can be employed. These tri-block copolymers include styrene groups as end blocks on the molecules and a rubber mid-block comprising approximately a 50/50 ratio of ethylene butylene and ethylene propylene. There are many other suitable gel materials that may be employed in place of or in addition to the SEEPS gel materials.

The present disclosure has been shown and described with reference to the foregoing embodiments. It is to be understood, however, that other forms, details and embodiments may be made without departing from the present disclosure.

What is claimed is:

1. A gel cushion having a top surface, a bottom surface and an outer periphery, the gel cushion comprising:
a first zone comprising a gel matrix configured in a first pattern designed to support an object positioned on the top surface with a first degree of firmness;
a second zone comprising a gel matrix configured in a second pattern that is different from the first pattern, the second pattern being designed to support an object positioned on the top surface with a second degree of firmness different from the first degree; and
an optional third zone comprising a gel matrix configured in a third pattern that is different from both the first pattern and the second pattern, the third pattern being designed to support an object positioned on the top surface with a third degree of firmness different from the first and the second degree.

2. The gel cushion of claim 1, comprising the third zone and further comprising a fourth zone containing a gel matrix configured in one of the first, second, or third patterns or a still different fourth pattern.

3. The gel cushion of claim 2, further comprising a fifth zone containing a gel matrix configured in one of the first, second, third, or optional fourth patterns or a still different fifth pattern.

4. The gel cushion of claim 3, wherein the first zone and the fifth zone are positioned at two opposite ends of the gel cushion, the second zone is positioned between the first zone and the third zone, and the fourth zone is positioned between the third zone and the fifth zone.

5. The gel cushion of claim 4, wherein the third zone has a higher ILD rating than both the second zone and the fourth zone, and both the second zone and the fourth zone have a higher ILD rating than both the first zone and the fifth zone.

6. The gel cushion of claim 1, wherein the first gel matrix pattern, the second gel matrix pattern and the third gel matrix pattern each form a plurality of hollow columns.

7. The gel cushion of claim 1, wherein the first gel matrix pattern, the second gel matrix pattern and the third gel matrix pattern each form a plurality of partially hollow columns.

8. The gel cushion of claim 1, wherein the first gel matrix pattern, the second gel matrix pattern and the third gel matrix pattern each form a plurality of hollow columns that are secondarily filled with other elastomeric or flexible materials that exhibit the property of collapsing under human body pressures.

9. The gel cushion of claim 1, wherein the first gel matrix is made of a different gel material than the second gel matrix.

10. The gel cushion of claim 1, wherein the first gel matrix and the second gel matrix are made of the same, continuous material.

11. The gel cushion of claim 1, wherein the first gel matrix and the second gel matrix are modular and are configured to be combined to form the gel cushion after separate manufacture.

12. The gel cushion of claim 1, wherein the gel cushion comprises a two-person sleep surface having a first person's side and a second person's side in the same gel cushion, the second person's side including at least two zones comprising respective gel matrices configured in at least two respectively different patterns at least one of which is different than the first, second, or optional third pattern of the first person's side

13. A gel cushion having a top surface, a bottom surface and an outer periphery, the gel cushion comprising:
a first zone and a fifth zone comprising a gel matrix configured in a first pattern designed to support an object positioned on the top surface with a first degree of firmness;
a second zone and a fourth zone comprising a gel matrix configured in a second pattern that is different from the first pattern, the second pattern being designed to support an object positioned on the top surface with a second degree of firmness different from the first degree; and
a third zone comprising a gel matrix configured in a third pattern that is different from both the first pattern and the second pattern, the third pattern being designed to support an object positioned on the top surface with a third degree of firmness different from the first and the second degree, the first zone and the fifth zone being positioned at two opposite ends of the gel cushion, the second zone being positioned between the first zone and the third zone, and the fourth zone being positioned between the third zone and the fifth zone.

14. The gel cushion of claim 13, wherein the third zone has a higher ILD rating than both the second zone and the fourth zone, and both the second zone and the fourth zone have a higher ILD rating than both the first zone and the fifth zone.

15. The gel cushion of claim 13, wherein the first gel matrix pattern, the second gel matrix pattern and the third gel matrix pattern each form a plurality of hollow columns.

16. The gel cushion of claim 13, wherein the first gel matrix pattern, the second gel matrix pattern and the third gel matrix pattern each form a plurality of partially hollow columns.

17. The gel cushion of claim 13, wherein the first gel matrix and the second gel matrix are made of the same, continuous material.

18. The gel cushion of claim 13, wherein the first gel matrix and the second gel matrix are modular and are configured to be combined to form the gel cushion after separate manufacture.

19. The gel cushion of claim 13, wherein the gel cushion comprises a two-person sleep surface having a first person's side and a second person's side in the same gel cushion, the second person's side including at least three zones comprising respective gel matrices configured in at least three respectively different patterns at least one of which is different than the first, second, or third patterns of the first person's side.

20. A gel cushion having a top surface, a bottom surface and an outer periphery, the gel cushion comprising a two-person sleep surface having a first person's side and a second person's side in the same gel cushion, the first person's side including:
a first zone comprising a gel matrix configured in a first pattern designed to support an object positioned on the top surface with a first degree of firmness;
a second zone comprising a gel matrix configured in a second pattern that is different from the first pattern, the second pattern being designed to support an object positioned on the top surface with a second degree of firmness different from the first degree;
a third zone comprising a gel matrix configured in a third pattern that is different from both the first pattern and the second pattern, the third pattern being designed to support an object positioned on the top surface with a third degree of firmness different from the first and the second degree;
a fourth zone containing a gel matrix configured in one of the first, second, or third patterns or a still different fourth pattern; and
a fifth zone containing a gel matrix configured in one of the first, second, third, or optional fourth patterns or a still different fifth pattern; and
the second person's side including:
a sixth, a seventh, and an eighth zone containing respective gel matrices configured in respectively different patterns;
a ninth zone containing a gel matrix configured in one of the patterns of the sixth through eighth zones or a still different pattern; and
a tenth zone containing a gel matrix configured in one of the patterns of the sixth through ninth zones or a still different pattern, at least one of the patterns of the sixth through tenth zones being different than the first, second, third, optional fourth, or optional fifth patterns of the first person's side.
